(19) United States
(12) Patent Application Publication
(10) Pub. No.: US 2008/0181432 A1
(43) Pub. Date: Jul. 31, 2008

(54) METHOD AND APPARATUS FOR ENCODING AND DECODING AUDIO SIGNAL

(75) Inventors: Jong-hoon Jeong, Suwon-si (KR); Geon-hyoung Lee, Hwaseong-si (KR); Jae-one Oh, Yongin-si (KR); Chul-woo Lee, Suwon-si (KR); Nam-suk Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/014,220

(22) Filed: Jan. 15, 2008

(30) Foreign Application Priority Data
Jan. 31, 2007 (KR) 10-2007-0010121

(51) Int. Cl. H04B 15/00

(52) U.S. Cl. 381/94.1

(57) ABSTRACT

Provided is a method of processing an audio signal. An apparatus for encoding an audio signal including: a reverberation signal analyzer analyzing reverberation signals included in an input audio signal and generating a filter coefficient; a reverberation signal remover removing the reverberation signals from the input audio signal using the filter coefficient; an audio encoder encoding the audio signal from which the reverberation signals are removed; and a signal combiner generating a signal that combines the encoded audio signal and the filter coefficient.

### CROSS-REFERENCE TO RELATED PATENT APPLICATIONS

This application claims priority from Korean Patent Application No. 10-2007-0010121, filed on Jan. 31, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to audio signal processing, and more particularly, to reverberation signal processing.

2. Description of the Related Art

In indoor spaces or tunnels where reflections frequently occur, sound propagates through a variety of routes, which creates reverberation. Reverberation is generally perceived as echo. However, reverberation is discriminated from echo in sound processing.

Echo implies a distinct version of the sound with a large delay time. The delay time typically lasts more than 50 milliseconds. Echo causes distortion of sound and reduces articulation of sound. Thus, it would be better to remove echo.

Meanwhile, the delay time of reverberation is typically shorter than 50 milliseconds. Reverberation makes sound rich and full and increases volume of sound. Therefore, it would be better to create sound including reverberation when audio signals are decoded in order to improve quality of sound.

When audio signals including reverberation signals are encoded, a great number of data bits are required. Accordingly, a method of efficiently encoding an audio signal including a reverberation signal is needed.

### SUMMARY OF THE INVENTION

The present invention provides an apparatus and method for efficiently encoding an audio signal including a reverberation signal, and a computer readable medium storing a program for executing the method.

The present invention also provides an apparatus and method for decoding an efficiently encoded audio signal, and a computer readable medium storing a program for executing the method.

According to an aspect of the present invention, there is provided an apparatus for encoding an audio signal comprising: a reverberation signal analyzer which analyzes reverberation signals included in an input audio signal and which generates a filter coefficient; a reverberation signal remover which removes the reverberation signals from the input audio signal using the filter coefficient; an audio encoder which encodes the audio signal from which the reverberation signals are removed; and a signal combiner which generates a signal that combines the encoded audio signal and the filter coefficient.

According to another aspect of the present invention, there is provided a method of encoding an audio signal comprising: analyzing reverberation signals included in an input audio signal and generating a filter coefficient; removing the reverberation signals from the input audio signal using the filter coefficient; encoding the audio signal from which the reverberation signals are removed; and generating a signal that combines the encoded audio signal and the filter coefficient.

The analyzing of the reverberation signals may comprise: analyzing the reverberation signals as a RTF.

The analyzing of the reverberation signals may further comprise: analyzing the reverberation signals as impulse responses that occur at different time.

The analyzing of the reverberation signals may further comprise: generating the filter coefficient to include occurrence times and SPLs of impulse responses.

The input audio signal may be obtained by convoluting the impulse responses to the audio signal from which the reverberation signals are removed.

The encoding of the audio signal may comprise: encoding the audio signal from which the reverberation signals are removed using a psychoacoustic model.

According to another aspect of the present invention, there is provided an apparatus for decoding an audio signal comprising: a signal separator which separates an encoded audio signal and a filter coefficient from a signal that combines the encoded audio signal and the filter coefficient, wherein the filter coefficient is generated by analyzing reverberation signals; an audio decoder which decodes the encoded audio signal; and a reverberation signal combiner which applies the filter coefficient to the decoded audio signal and which generates an output audio signal including reverberation signals.

According to another aspect of the present invention, there is provided a method of decoding an audio signal comprising: separating an encoded audio signal and a filter coefficient from a signal that combines the encoded audio signal and the filter coefficient; decoding the encoded audio signal; and applying the filter coefficient to the decoded audio signal and generating an output audio signal including reverberation signals.

The filter coefficient may include occurrence times and SPLs of impulse responses that occur at different times.

The generating of the output audio signal including the reverberation may comprise: generating the reverberation signals as impulse responses that occur at different time using the filter coefficient.

### BRIEF DESCRIPTION OF THE DRAWINGS

The above and other features of the present invention will become more apparent by describing in detail exemplary embodiments thereof with reference to the attached drawings in which:

FIG. 1 is a block diagram of an apparatus for encoding an audio signal according to an exemplary embodiment of the present invention;

FIG. 2 is a block diagram of an apparatus for decoding an audio signal according to an exemplary embodiment of the present invention;

FIG. 3 illustrates the propagation of reverberation signals in a room according to an exemplary embodiment of the present invention; and

FIG. 4 is a graph illustrating impulse response characteristics of reverberation signals according to an exemplary embodiment of the present invention.

### DETAILED DESCRIPTION OF THE INVENTION

The present invention will now be described more fully with reference to the accompanying drawings, in which exemplary embodiments of the invention are shown.

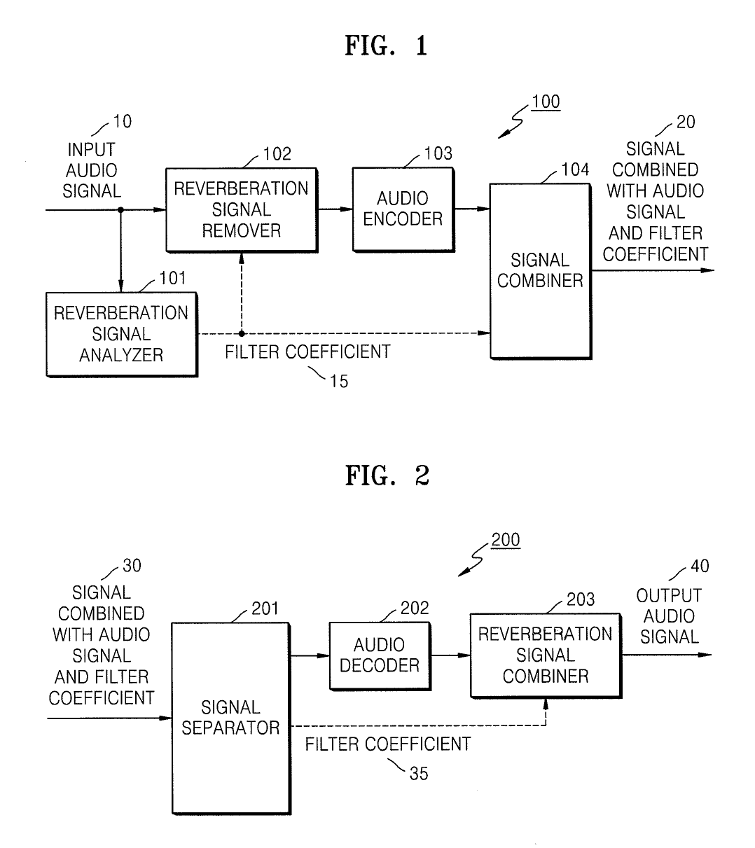

FIG. 1 is a block diagram of an apparatus 100 for encoding an audio signal according to an exemplary embodiment of the present invention. Referring to FIG. 1, the apparatus 100 for encoding the audio signal comprises a reverberation signal analyzer 101, a reverberation signal remover 102, an audio encoder 103, and a signal combiner 104.

The reverberation signal analyzer 101 analyzes reverberation signals included in an input audio signal 10 and generates a filter coefficient 15. The reverberation signal analyzer 101 analyzes the reverberation signals in the format of a room transfer function (RTF).

A reverberation signal is related to the original sound signal. The reverberation signal is the persistence of sound delayed in time after the original sound signal. If the degree of the persistence and time delay can be defined, it is possible to analyze the reverberation signal using the RTF.

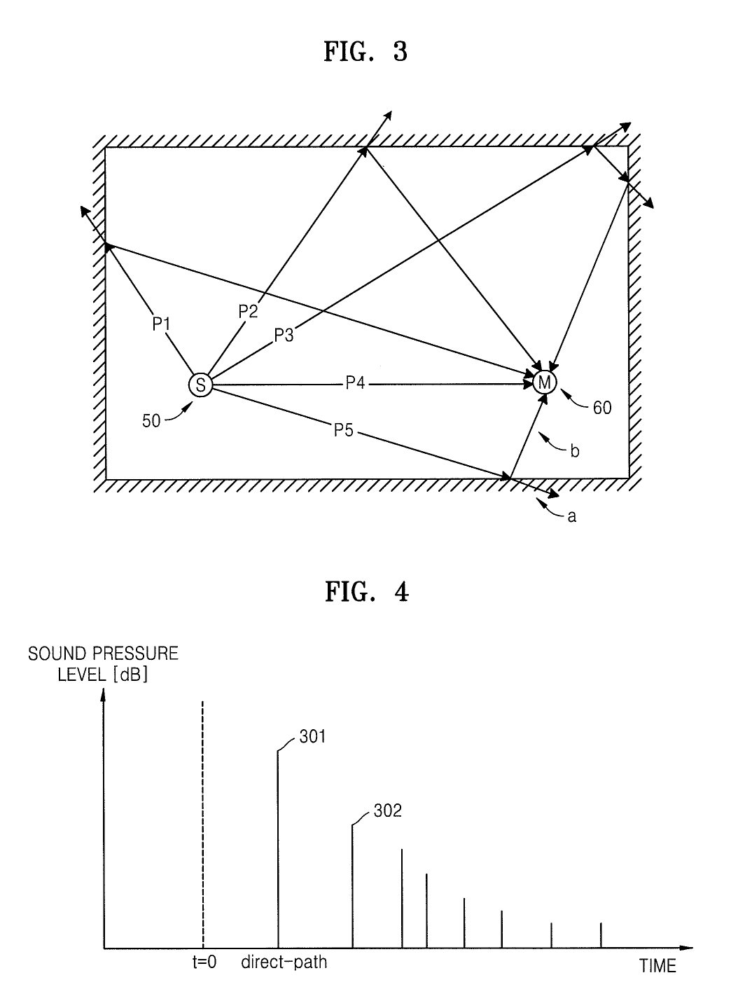

The RTF will be described in detail with reference to FIG. 3.

The reverberation signal analyzer 101 can include an impulse response analyzer for analyzing the reverberation signals as impulse responses that occur at different time.

In view of a transfer function domain, the reverberation signal is obtained by multiplying the original sound signal by an impulse response. In view of a time domain, the reverberation signal is the convolution of the impulse response and the original sound signal.

The filter coefficient 15 may include occurrence time and sound pressure levels (SPLs) of the impulse responses corresponding to reverberation signals.

The impulse response analyzer will be described in detail with reference to FIG. 4.

The reverberation signal remover 102 removes the reverberation signals from the input audio signal 10 using the filter coefficient 15.

The audio encoder 103 encodes the audio signal from which the reverberation signals are removed. The audio encoder 103 may encode the audio signal using a psychoacoustic model. Examples of the audio encoder 103 are AAC (Advanced Audio Coding), MP3 (MPEG-1 Audio Layer-3), WMA (Windows Media Audio), BSAC (Bit Sliced Arithmetic Coding), and the like.

The signal combiner 104 combines the encoded audio signal and the filter coefficient 15 to generate a signal 20.

FIG. 2 is a block diagram of an apparatus 200 for decoding an audio signal according to an exemplary embodiment of the present invention. Referring to FIG. 2, the apparatus 200 for decoding the audio signal may comprise a signal separator 201, an audio decoder 202, and a reverberation signal combiner 203.

The signal separator 201 separates an encoded audio signal and a filter coefficient 35 from a signal 30 that combines an encoded audio signal and a filter coefficient.

The filter coefficient 35 is identical to the filter coefficient 15 generated by analyzing the reverberation signals by the apparatus 100 for encoding the audio signal illustrated in FIG. 1. In the previous exemplary embodiment where the apparatus 100 for encoding the audio signal analyzes the reverberation signals as the impulse responses that occur at different times, the filter coefficient 35 may include the occurrence times and SPLs of the impulse responses corresponding to reverberation signals that occur at different times.

The audio decoder 202 decodes the encoded audio signal.

The reverberation signal combiner 203 applies the filter coefficient 35 to the decoded audio signal and generates an output audio signal 40 including reverberation signals. In the previous exemplary embodiment where the apparatus 100 for encoding the audio signal analyzes the reverberation signals as the impulse responses, the reverberation signal combiner 203 can generate the reverberation signals as the impulse responses that occur at different time using the filter coefficient 35.

FIG. 3 illustrates the propagation of reverberation signals in a room according to an exemplary embodiment of the present invention. Referring to FIG. 3, two types of audio signals propagate in the room from sound source 50 to an object 60, e.g., a mike, through a medium (air). A signal P4 directly propagates. Some signals P1, P2, P3, and P5 are reflected and then propagate. Some of the reflection signal P5, a, is absorbed in a reflection subject (walls). Some of the reflection signal P5, b, is reflected and then propagates to the object 60.

The signal P4 that directly propagates is the original sound signal. The signals P1, P2, P3, and P5 that are reflected and then propagate are the reverberation signals. The propagation of the reverberation signals in the room can be approximated with mathematical modeling. For example, the propagation of the reverberation signals in the room can be expressed by the RTF.

FIG. 4 is a graph illustrating impulse response characteristics of reverberation signals according to an exemplary embodiment of the present invention. Referring to FIG. 4, an impulse response (t=0) is output from sound source 50 illustrated in FIG. 3, and reverberation signals 301 and 302 that propagate to the object 60 illustrated in FIG. 3 are measured in order to compute the RTF. According to the sound transfer characteristics, sound propagates via numerous routes as shown in FIG. 3. Therefore, the reverberation signals 301 and 302 are expressed as impulse responses having different time and SPLs. For example, an impulse response 301 corresponds to the signal P4 shown in FIG. 3 that directly propagates from the sound source 50 to the object 60. An impulse response 302 corresponds to the signal P5 shown in FIG. 3 that is reflected and then propagates.

An audio signal x(t) input at time t is expressed below,

$$x ( t ) = {\sum }_{k = 1}^{N} h ( k ) s ( t - k ) \qquad ( 1 )$$

wherein h(k)(k=1, . . . , N) denote the impulse responses having different time and SPLs, and s(t) denotes the original sound signal.

Each of the reverberation signals 301 and 302 is obtained by multiplying each impulse response by the original sound signal. The whole audio signal is the convolution of the impulse response and the original sound signal.

The audio signal processing according to the present invention, in particular, minimizes the effect due to a transient signal which is a rapidly varying signal. The transient signal causes a pre-echo phenomenon that greatly deteriorates quality of sound when an audio signal is compressed using the psychoacoustic modeling. Therefore, the present invention minimizes the effect caused by the transient signal, thereby improving the quality of sound.

Further, the present invention does not wholly encode an audio signal including a reverberation signal but encodes the audio signal from which the reverberation signal is removed and combines information on the reverberation signal and the audio signal, thereby reducing the amount of data transmission, which increases encoding efficiency.

The present invention separates the reverberation signal from the audio signal, encodes the audio signal, and combines the reverberation signal and the encoded audio signal, thereby making rich and full sound and increasing volume of sound.

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

As described above, the apparatuses and methods for encoding and decoding an audio signal of the present invention analyze reverberation components using a RTF, and apply a mathematical model of the reverberation components to an encoded or decoded audio signal, thereby minimizing the effect caused by a transient signal and feeling rich volume of sound. The present invention also separates information on the reverberation components from the audio signal and encodes the audio signal, thereby increasing coding efficiency.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for encoding an audio signal comprising:
a reverberation signal analyzer which analyzes reverberation signals included in an input audio signal and which generates a filter coefficient;
a reverberation signal remover which removes the reverberation signals from the input audio signal using the filter coefficient;
an audio encoder which encodes the input audio signal from which the reverberation signals are removed to generate an encoded audio signal; and
a signal combiner which combines the encoded audio signal and the filter coefficient.

2. The apparatus of claim 1, wherein the reverberation signal analyzer analyzes the reverberation signals using a room transfer function (RTF).

3. The apparatus of claim 1, wherein the reverberation signal analyzer comprises: an impulse response analyzer which analyzes the reverberation signals as impulse responses that occur at different times.

4. The apparatus of claim 3, wherein the filter coefficient includes occurrence times of impulse responses and sound pressure levels (SPLs) of impulse responses.

5. The apparatus of claim 3, wherein the input audio signal is obtained by convoluting the impulse responses to the input audio signal from which the reverberation signals are removed.

6. The apparatus of claim 1, wherein the audio encoder encodes the input audio signal from which the reverberation signals are removed using a psychoacoustic model.

7. A method of encoding an audio signal comprising:
analyzing reverberation signals included in an input audio signal and generating a filter coefficient;
removing the reverberation signals from the input audio signal using the filter coefficient;
encoding the input audio signal from which the reverberation signals are removed to generate an encoded audio signal; and
combining the encoded audio signal and the filter coefficient.

8. The method of claim 7, wherein the analyzing of the reverberation signals comprises: analyzing the reverberation signals using a room transfer function (RTF).

9. The method of claim 7, wherein the analyzing of the reverberation signals further comprises: analyzing the reverberation signals as impulse responses that occur at different times.

10. The method of claim 9, wherein the analyzing of the reverberation signals further comprises: generating the filter coefficient to include the different times and sound pressure levels (SPLs) of the impulse responses.

11. The method of claim 9, wherein the input audio signal is obtained by convoluting the impulse responses to the input audio signal from which the reverberation signals are removed.

12. The method of claim 7, wherein the encoding of the audio signal comprises: encoding the input audio signal from which the reverberation signals are removed using a psychoacoustic model.

13. An apparatus for decoding an audio signal comprising:
a signal separator which separates an encoded audio signal and a filter coefficient from a signal, the filter coefficient being generated by analyzing reverberation signals;
an audio decoder which decodes the encoded audio signal to generate a decoded audio signal; and
a reverberation signal combiner which applies the filter coefficient to the decoded audio signal and which generates an output audio signal including reverberation signals.

14. The apparatus of claim 13, wherein the filter coefficient includes occurrence times of impulse responses and sound pressure levels (SPLs) of impulse responses that occur at different times.

15. The apparatus of claim 14, wherein the reverberation signal combiner generates the reverberation signals as impulse responses that occur at different time using the filter coefficient.

16. A method of decoding an audio signal comprising:
separating an encoded audio signal and a filter coefficient from a signal, the filter coefficient being generated by analyzing reverberation signals;
decoding the encoded audio signal to generate a decoded audio signal; and
applying the filter coefficient to the decoded audio signal and generating an output audio signal including reverberation signals.

17. The method of claim 16, wherein the filter coefficient includes occurrence times of impulse responses and sound pressure levels (SPLs) of impulse responses that occur at different times.

18. The method of claim 17, wherein the generating of the output audio signal including the reverberation comprises: generating the reverberation signals as impulse responses that occur at different times using the filter coefficient.

19. A computer-readable recording medium having recorded thereon a program for executing a method of decoding an audio signal, wherein the method comprises:
separating an encoded audio signal and a filter coefficient from a signal, the filter coefficient being generated by analyzing reverberation signals;
decoding the encoded audio signal to generate a decoded audio signal; and
applying the filter coefficient to the decoded audio signal and generating an output audio signal including reverberation signals.
